(19) United States
(12) Patent Application Publication
(10) Pub. No.: US 2024/0333639 A1
(43) Pub. Date: Oct. 3, 2024

(54) MULTI-STAGE INTERCONNECTION NETWORK USING PLANE ROUTING NETWORK AND DESTINATION ROUTING NETWOTK AND ASSOCIATED CONTROL METHOD

(71) Applicant: MEDIATEK INC., Hsin-Chu (TW)

(72) Inventors: En-Jui Chang, Hsinchu City (TW); Chih-Chung Cheng, Hsinchu City (TW)

(73) Assignee: MEDIATEK INC., Hsin-Chu (TW)

(21) Appl. No.: 18/128,215

(22) Filed: Mar. 29, 2023

(51) Int. Cl. H04L 45/42; H04L 41/16; H04L 45/02

(52) U.S. Cl. CPC H04L 45/42; H04L 41/16; H04L 45/02

(57) ABSTRACT

A multi-stage interconnection network includes an M-stage plane routing network and an N-stage destination routing network. The M-stage plane routing network routes a data packet received by an input port of the multi-stage interconnection network to a switch plane according to an M-bit entry selected from a plane encoding table, wherein M bits of the M-bit entry control M stages of the M-stage plane routing network, respectively. The N-stage destination routing network routes the data packet from the switch plane to at least one output port of the multi-stage interconnection network according to at least one N-bit entry selected from a destination encoding table, wherein N bits of each of the at least one N-bit entry control N stages of the N-stage destination routing network, respectively. The multi-stage interconnection network employs a non-blocking network topology.

### BACKGROUND

The present invention relates to interconnection architecture, and more particularly, to a multi-stage interconnection network using a plane routing network and a destination routing network and an associated control method.

Some applications, such as image processing, speech recognition, and classification, heavily rely on neural network based algorithms that have demonstrated highly promising results in accuracy. However, such algorithms involve massive computations that are not manageable in general purpose processors. To cope with this challenge, a spatial architecture based accelerator that includes an array of computing engines (CEs) has emerged. For example, a spatial deep neural network (DNN) accelerator may be employed due to the highly parallel nature of the DNN computation. The typical spatial DNN accelerator, however, may suffer from high overhead of on-chip data movement between an on-chip memory and a plurality of CEs. For example, an interconnection network of the typical spatial DNN accelerator may not consider the types of data movement, thus resulting in additional overhead of the on-chip data movement due to lack of the multicast/broadcast functionality; and/or may be unaware of characteristic of data reuse, thus resulting in high energy consumption due to a large number of memory accesses.

Thus, there is a need for an innovative interconnection network capable of fully utilizing the data reuse opportunity.

### SUMMARY

One of the objectives of the claimed invention is to provide a multi-stage interconnection network using a plane routing network and a destination routing network and an associated control method. In one application, the multi-stage interconnection network may be a part of a spatial deep neural network (DNN) accelerator. In another application, the multi-stage interconnection network may be a part of a network-on-chip (NoC) based artificial intelligence (AI) cloud server.

According to a first aspect of the present invention, an exemplary multi-stage interconnection network is disclosed. The exemplary multi-stage interconnection network includes an M-stage plane routing network and an N-stage destination routing network. The M-stage plane routing network is arranged to route a data packet received by an input port of the multi-stage interconnection network to a switch plane according to an M-bit entry selected from a plane encoding table, wherein M bits of the M-bit entry control M stages of the M-stage plane routing network, respectively. The N-stage destination routing network is arranged to route the data packet from the switch plane to at least one output port of the multi-stage interconnection network according to at least one N-bit entry selected from a destination encoding table, wherein N bits of each of the at least one N-bit entry control N stages of the N-stage destination routing network, respectively. The multi-stage interconnection network employs a non-blocking network topology, and a sum of M and N is a positive integer not smaller than two.

According to a second aspect of the present invention, an exemplary control method of a multi-stage interconnection network is disclosed. The exemplary control method includes: selecting an M-bit entry from a plane encoding table for controlling an M-stage plane routing network included in the multi-stage interconnection network to route a data packet received by an input port of the multi-stage interconnection network to a switch plane, wherein Mbits of the M-bit entry control M stages of the M-stage plane routing network, respectively; and selecting at least one N-bit entry from a destination encoding table for controlling an N-stage destination routing network included in the multi-stage interconnection network to route the data packet from the switch plane to at least one output port of the multi-stage interconnection network, wherein N bits of each of the at least one N-bit entry control N stages of the N-stage destination routing network, respectively. The multi-stage interconnection network employs a non-blocking network topology, and a sum of M and N is a positive integer not smaller than two.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a spatial DNN accelerator according to an embodiment of the present invention.

FIG. 2 is a diagram illustrating an example of a multi-stage interconnection network shown in FIG. 1.

FIG. 3 is a diagram illustrating a 2×2 switch that supports up-down routing according to an embodiment of the present invention.

FIG. 4 is a diagram illustrating the 2×2 switch operating in a first multicast mode according to an embodiment of the present invention.

FIG. 5 is a diagram illustrating the 2×2 switch operating in a second multicast mode according to an embodiment of the present invention.

FIG. 6 is a diagram illustrating the 2×2 switch operating in a first unicast mode according to an embodiment of the present invention.

FIG. 7 is a diagram illustrating the 2×2 switch operating in a second unicast mode according to an embodiment of the present invention.

FIG. 8 is a diagram illustrating an example of a destination encoding table according to an embodiment of the present invention.

FIG. 9 is a diagram illustrating an example of a plane encoding table according to an embodiment of the present invention.

FIG. 10 is a diagram illustrating one design rule of the plane encoding table according to an embodiment of the present invention.

FIG. 11 is a diagram illustrating another design rule of the plane encoding table according to an embodiment of the present invention.

FIG. 12 is a diagram illustrating yet another design rule of the plane encoding table according to an embodiment of the present invention.

FIG. 13 is a flowchart illustrating an up-down routing method according to an embodiment of the present invention.

FIG. 14 is a diagram illustrating a multicast routing operation achieved through the multi-stage interconnection network according to an embodiment of the present invention.

FIG. 15 is a diagram illustrating one unicast routing operation achieved through the multi-stage interconnection network according to an embodiment of the present invention.

FIG. 16 is a diagram illustrating another unicast routing operation achieved through the multi-stage interconnection network according to an embodiment of the present invention.

FIG. 17 is a diagram illustrating a first type of a low-power multicast mode of the multi-stage interconnection network according to an embodiment of the present invention.

FIG. 18 is a diagram illustrating a second type of the low-power multicast mode of the multi-stage interconnection network according to an embodiment of the present invention.

FIG. 19 is a diagram illustrating a third type of the low-power multicast mode of the multi-stage interconnection network according to an embodiment of the present invention.

FIG. 20 is a diagram illustrating an NoC-based AI cloud server according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

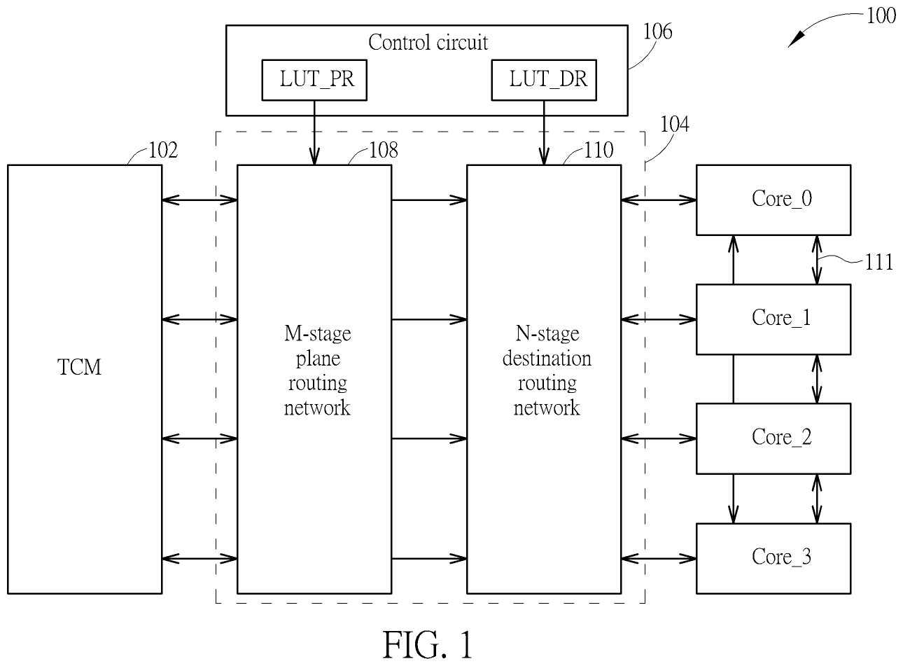

FIG. 1 is a block diagram illustrating a spatial DNN accelerator according to an embodiment of the present invention. The spatial DNN accelerator 100 includes an on-chip memory such as a tightly coupled memory (TCM) 102, a multi-stage interconnection network 104, a plurality of computing engines (CEs) such as processor cores Core_0, Core_1, Core_2, Core_3, and a control circuit 106. The local traffic between the processor cores Core_0-Core_3 (i.e. inter-CE communication traffic) may be achieved through a ring network 111. It should be noted that only four processor cores are shown in FIG. 1 for illustrative purposes only. In practice, the number of processor cores in the spatial DNN accelerator 100 can be adjusted, depending upon actual application requirements. Regarding the multi-stage interconnection network 104, it is responsible for the on-chip data movement between TCM 102 and processor cores Core_0-Core_3. The multi-stage interconnection network 104 proposed by the present invention includes an M-stage plane routing network 108 and an N-stage destination routing network 110, where M and N are positive integers, and the sum of M and N is not smaller than 2. The control circuit 106 is arranged to manage the plane route of the M-stage plane routing network 108 according to a plane encoding table LUT_PR, and manage the destination route of the N-stage destination routing network 110 according to a destination encoding table LUT_DR. For example, the M-stage plane routing network 108 routes a data packet received by an input port of the multi-stage interconnection network 108 to a switch plane (which may be regarded as an intermediate plane during packet forwarding) according to an M-bit entry selected from the plane encoding table LUT_PR, wherein M bits of each M-bit entry control M stages of the M-stage plane routing network 108, respectively; and the N-stage destination routing network 110 routes the data packet from the switch plane to at least one output port of the multi-stage interconnection network 104 according to at least one N-bit entry selected from the destination encoding table LUT_DR, wherein N bits of each N-bit entry control N stages of the N-stage destination routing network 110, respectively. By way of example, but not limitation, the plane encoding table LUT_PR may be configurable, and the destination encoding table LUT_DR may be fixed (pre-defined). In the following, the terms “switch plane” and “intermediate plane” may be interchangeable.

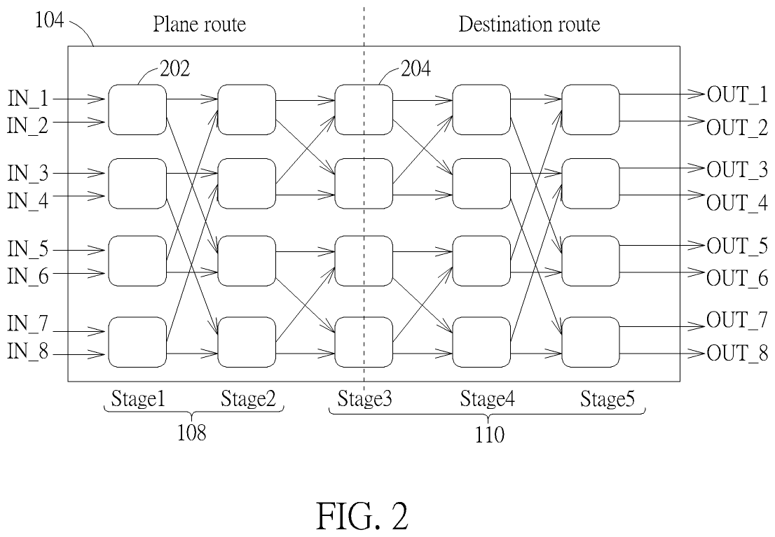

Regarding the on-chip data movement of DNN dataflow, the multi-stage interconnection network 104 employs a non-blocking network topology, and supports a multicast/broadcast (one-to-many) function for spatial data reuse and a unicast (one-to-one) function for parallel data access. FIG. 2 is a diagram illustrating an example of the multi-stage interconnection network 104 shown in FIG. 1. In this example, the multi-stage interconnection network 104 employs a Benes topology, and therefore has distributed 2×2 switch architecture. As shown in FIG. 2, the multi-stage interconnection network 104 has eight input ports IN_1-IN_8 and eight output ports OUT_1-OUT_8, the plane routing network 108 has two stages Stage1 and Stage2 (M=2), and the destination routing network 110 has three stages Stage3, Stage4, and Stage5 (N=3). Each stage of the plane routing network 108 includes four 2×2 switches 202, and each stage of the destination routing network 110 includes four 2×2 switches 204.

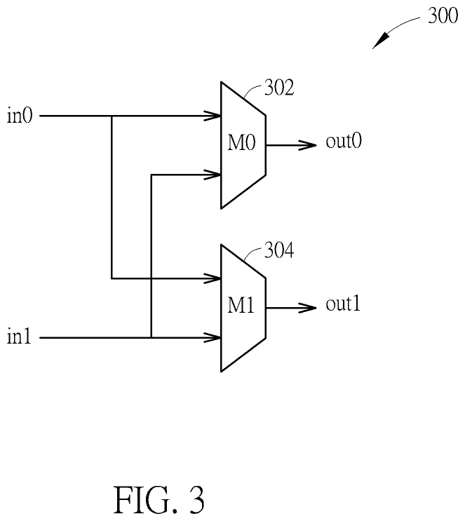

For example, each of the 2×2 switches 202 and 204 may be implemented by the 2×2 switch 300 shown in FIG. 3. As shown in FIG. 3, the 2×2 switch 300 includes two multiplexers 302 and 304 that are labeled by M0 and M1, respectively. With proper settings of the multiplexers 302 and 304, the 2×2 switch 300 may support four possible switch modes. In this example, an up route is selected when a control bit of the 2×2 switch 300 is set by “0”, and a down route is selected when a control bit of the 2×2 switch 300 is set by “1”.

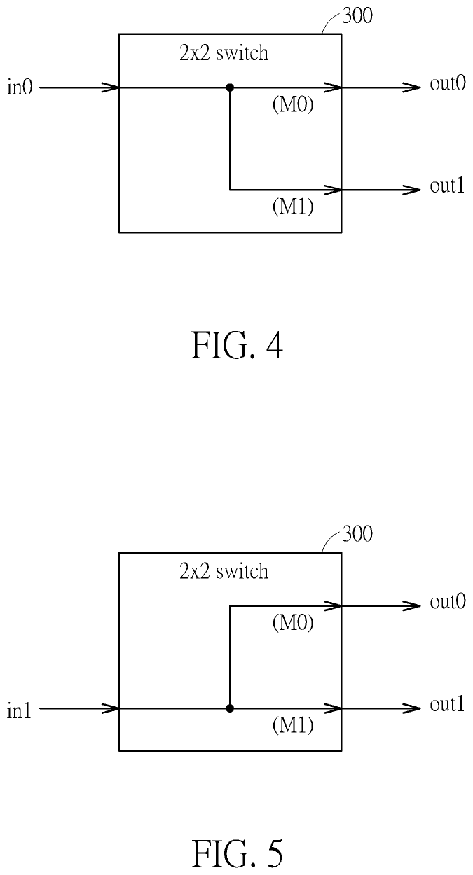

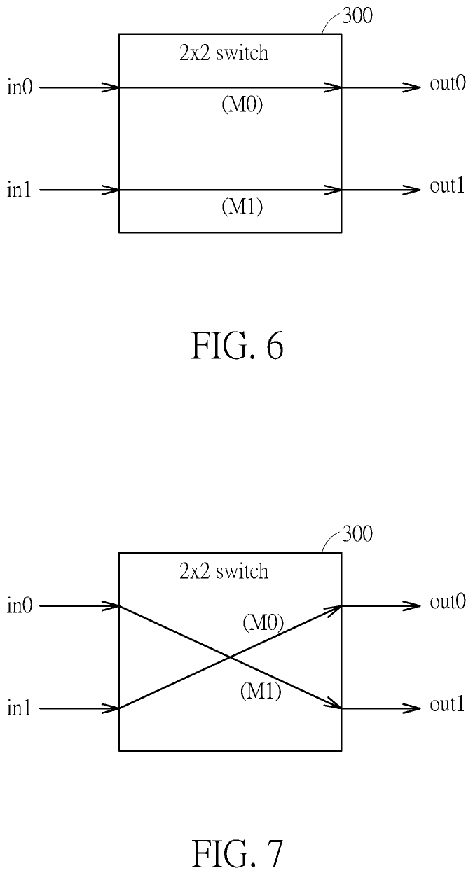

As shown in FIG. 4, the 2×2 switch 300 may operate in a first multicast mode when the multiplexer 302 is instructed to output the input in0 as its output out0 and the multiplexer 304 is instructed to output the same input in0 as its output out1. As shown in FIG. 5, the 2×2 switch 300 may operate in a second multicast mode when the multiplexer 302 is instructed to output the input in1 as its output out0 and the multiplexer 304 is instructed to output the same input in1 as its output out1. As shown in FIG. 6, the 2×2 switch 300 may operate in a first unicast mode (also called “pass mode” hereinafter) when the multiplexer 302 is instructed to output the input in0 as its output out0 and the multiplexer 304 is instructed to output the input in1 as its output out1. As shown in FIG. 7, the 2×2 switch 300 may operate in a second unicast mode (also called “cross mode” hereinafter) when the multiplexer 302 is instructed to output the input in1 as its output out0 and the multiplexer 304 is instructed to output the input in0 as its output out1.

In this example, each of the 2×2 switches 204 included in the destination routing network 110 shown in FIG. 2 is allowed to operate in any of the four switch modes shown in FIG. 4-FIG. 7. Regarding each of the 2×2 switches 202 included in the plane routing network 108 shown in FIG. 2, it is constrained to operate in one of only two switch modes shown in FIG. 6 and FIG. 7. That is, in accordance with the routing algorithm, each of the 2×2 switches 202 is required to operate in either a pass mode shown in FIG. 6 or a cross mode shown in FIG. 7.

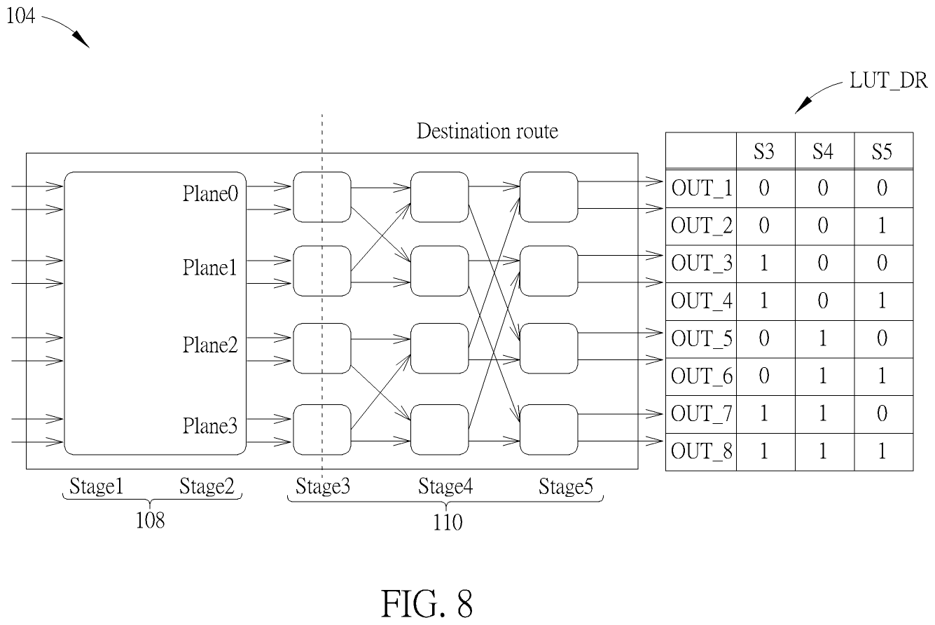

FIG. 8 is a diagram illustrating an example of the destination encoding table LUT_DR according to an embodiment of the present invention. The destination encoding table LUT_DR is a fixed table that defines fixed up-down routes for different destinations (i.e. output ports OUT_1-OUT_8). Since a fixed destination encoding table is employed, complexity reduction of the routing algorithm for the multi-stage interconnection network 104 can be achieved. In this example, a 3-stage destination routing network is employed. Hence, each entry of the destination encoding table LUT_DR is indexed by a destination identifier, and includes 3 control bits S3, S4, S5, where the control bit S3 is used to control a 2×2 switch at Stage3, the control bit 4 is used to control a 2×2 switch at Stage4, and the control bit S5 is used to control a 2×2 switch at Stage5. Regarding a 2×2 switch, an up route is selected when a control bit is set by “0”, and a down route is selected when a control bit is set by “1”. Specifically, each 2×2 switch of the destination routing network 110 is allowed to operate in any of four switch modes shown in FIG. 4-FIG. 7. The destination route specified by the destination routing network 110 can support unicast & multicast. Regarding each destination, any switch plane can reach it through a destination route specified by the destination routing network 110.

For example, when a data packet is forwarded to any of switch planes Plane0, Plane1, Plane2, and Plane3 through the plane routing network 108, the data packet can be further forwarded to the output port OUT_1 through a destination route (Up, Up, Up) provided by 2×2 switches at consecutive Stage3, Stage4, and Stage5 of the destination routing network 110 in response to (S3, S4, S5)=(0, 0, 0) selected for the destination being the output port OUT_1; the data packet can be further forwarded to the output port OUT_2 through a destination route (Up, Up, Down) provided by 2×2 switches at consecutive Stage3, Stage4, and Stage5 of the destination routing network 110 in response to (S3, S4, S5)=(0, 0, 1) selected for the destination being the output port OUT_2; the data packet can be further forwarded to the output port OUT_3 through a destination route (Down, Up, Up) provided by 2×2 switches at consecutive Stage3, Stage4, and Stage5 of the destination routing network 110 in response to (S3, S4, S5)=(1, 0, 0) selected for the destination being the output port OUT_3; the data packet can be further forwarded to the output port OUT_4 through a destination route (Down, Up, Down) provided by 2×2 switches at consecutive Stage3, Stage4, and Stage5 of the destination routing network 110 in response to (S3, S4, S5)=(1, 0, 1) selected for the destination being the output port OUT_4; the data packet can be further forwarded to the output port OUT_5 through a destination route (Up, Down, Up) provided by 2×2 switches at consecutive Stage3, Stage4, and Stage5 of the destination routing network 110 in response to (S3, S4, S5)=(0, 1, 0) selected for the destination being the output port OUT_5; the data packet can be further forwarded to the output port OUT_6 through a destination route (Up, Down, Down) provided by 2×2 switches at consecutive Stage3, Stage4, and Stage5 of the destination routing network 110 in response to (S3, S4, S5)=(0, 1, 1) selected for the destination being the output port OUT_6; the data packet can be further forwarded to the output port OUT_7 through a destination route (Down, Down, Up) provided by 2×2 switches at consecutive Stage3, Stage4, and Stage5 of the destination routing network 110 in response to (S3, S4, S5)=(1, 1, 0) selected for the destination being the output port OUT_7; and the data packet can be further forwarded to the output port OUT_8 through a destination route (Down, Down, Down) provided by 2×2 switches at consecutive Stage3, Stage4, and Stage5 of the destination routing network 110 in response to (S3, S4, S5)=(1, 1, 1) selected for the destination being the output port OUT_8.

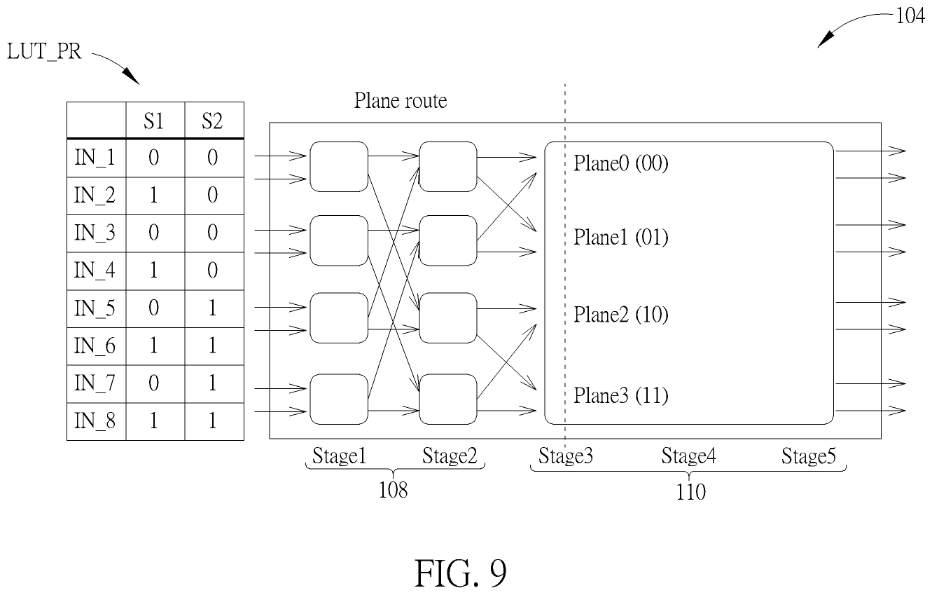

FIG. 9 is a diagram illustrating an example of the plane encoding table LUT_PR according to an embodiment of the present invention. The plane encoding table LUT_PR is a configurable table that assigns switch planes to different sources (i.e. input ports IN_1-IN_8). Since the plane encoding table LUT_PR is configurable, the plane routing network 108 can provide path diversity as needed. For example, since the data packet forwarding paths provided by the plane routing network 108 can be adjusted through properly changing settings of the configurable plane encoding table LUT_PR, the multi-stage interconnection network can benefit from the path diversity feature of the plane routing network 108 to avoid path contention. In this example, a 2-stage plane routing network is employed. Hence, each entry of the plane encoding table LUT_PR is indexed by a source identifier, and includes 2 control bits S1 and S2, where the control bit S1 is used to control a 2×2 switch at Stage1, and the control bit S2 is used to control a 2×2 switch at Stage2. Regarding a 2×2 switch, an up route is selected when a control bit is set by “0”, and a down route is selected when the control bit is set by “1”. In accordance with the routing algorithm, each 2×2 switch of the plane routing network 108 is constrained to operate in one of two switch modes (i.e. pass mode and cross mode) shown in FIG. 6-FIG. 7.

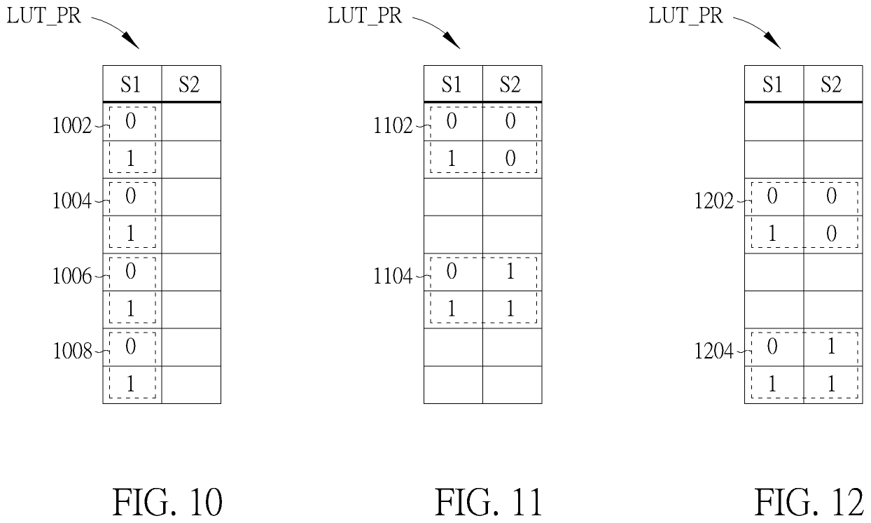

To meet the switch mode constraints (i.e. pass mode and cross mode), the configuration of the plane encoding table LUT_PR may follow the design rules as illustrated in FIG. 10-FIG. 11. Regarding the control bits S1 included in each of the dashed-line boxes 1002, 1004, 1006, and 1008 shown in FIG. 10, they should be exclusive, that is, “0” and “1”. It should be noted that the order of “0” and “1” in the same dashed-line box 1002/1004/1006/1008 may be switched, depending upon actual design considerations. Regarding the control bit pairs (S1, S2) included in the dashed-line boxes 1102 and 1104 shown in FIG. 11, they should be exclusive, that is, “00”, “10”, “01”, and “11”. It should be noted that the order of “00”, “10”, “01” and “11” in the dashed-line boxes 1102 and 1104 may be adjusted, depending upon actual design considerations. Regarding the control bit pairs (S1, S2) included in the dashed-line boxes 1202 and 1204 shown in FIG. 12, they should be exclusive, that is, “00”, “10”, “01”, and “11”. It should be noted that the order of “00”, “10”, “01” and “11” in the dashed-line boxes 1202 and 1204 may be adjusted, depending upon actual design considerations.

The plane encoding assigns a switch plane to an input plane. Taking the plane encoding table LUT_PR shown in FIG. 9 for example, the input port IN_1 is assigned with (S1, S2)=(0, 0), the input port IN_2 is assigned with (S1, S2)=(1, 0), the input port IN_3 is assigned with (S1, S2)=(0, 0), the input port IN_4 is assigned with (S1, S2)=(1, 0), the input port IN_5 is assigned with (S1, S2)=(0, 1), the input port IN_6 is assigned with (S1, S2)=(1, 1), the input port IN_7 is assigned with (S1, S2)=(0, 1), and the input port IN_8 is assigned with (S1, S2)=(1, 1). Hence, when a data packet is received by any of input ports IN_1 and IN_3, the data packet is forwarded to the switch plane Plane0 through a plane route (Up, Up) provided by 2×2 switches at consecutive Stage1 and Stage2 of the plane routing network 108 in response to (S1, S2)=(0, 0) selected for the source being the input port IN_1/IN_3; when a data packet is received by any of input ports IN_5 and IN_7, the data packet is forwarded to the switch plane Plane1 through a plane route (Up, Down) provided by 2×2 switches at consecutive Stage1 and Stage2 of the plane routing network 108 in response to (S1, S2)=(0, 1) selected for the source being the input port IN_5/IN_7; when a data packet is received by any of input ports IN_2 and IN_4, the data packet is forwarded to the switch plane Plane2 through a plane route (Down, Up) provided by 2×2 switches at consecutive Stage1 and Stage2 of the plane routing network 108 in response to (S1, S2)=(1, 0) selected for the source being the input port IN_2/IN_4; and when a data packet is received by any of input ports IN_6 and IN_8, the data packet is forwarded to the switch plane Plane3 through a plane route (Down, Down) provided by 2×2 switches at consecutive Stage1 and Stage2 of the plane routing network 108 in response to (S1, S2)=(1, 1) selected for the source being the input port IN_6/IN_8.

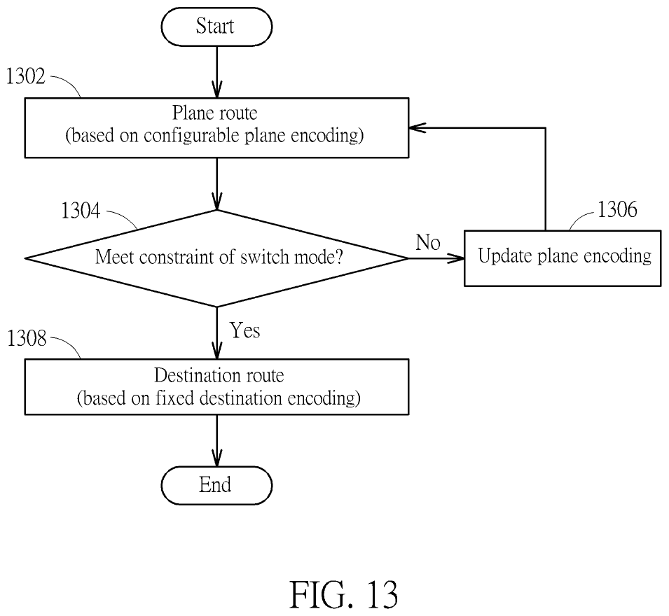

FIG. 13 is a flowchart illustrating an up-down routing method according to an embodiment of the present invention. Provided that the result is substantially the same, the steps are not required to be executed in the exact order shown in FIG. 13. At step 1302, the plane route is set by configuring the plane encoding table LUT_PR. Hence, a designer/user can manually set the plane encoding table LUT_PR to meet requirements of an application. At step 1304, the plane encoding table LUT_PR is checked to determine if the switch mode constraints are met. If the switch mode constraints are not met, the plane encoding table LUT_PR is updated (step 1306). If the switch mode constraints are met, the destination route is directly set by using the fixed (pre-defined) destination encoding table LUT_DR (step 1308). Hence, the designer/user has to set the plane encoding table LUT_PR manually, but does not need to spend time on setting the destination encoding table LUT_DR manually.

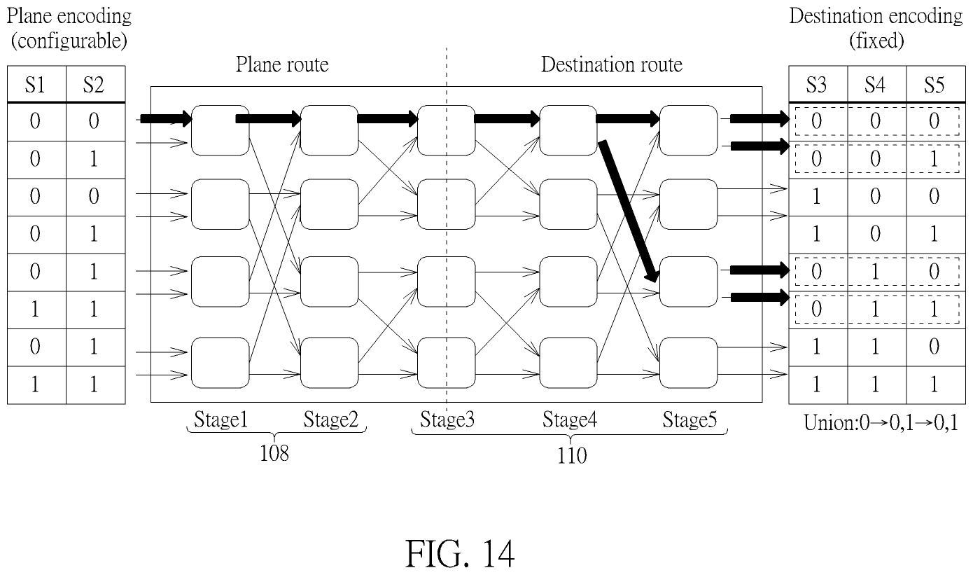

The multi-stage interconnection network 104 employs a non-blocking network topology (e.g. Benes topology), and supports a multicast/broadcast (one-to-many) function for spatial data reuse and a unicast (one-to-one) function for parallel data access. Please refer to FIG. 14 in conjunction with FIG. 8 and FIG. 9. FIG. 14 is a diagram illustrating a multicast routing operation achieved through the multi-stage interconnection network 104 according to an embodiment of the present invention. Suppose that the same data packet received by the input port IN_1 of the multi-stage interconnection network 104 is required to be forwarded to multiple output ports OUT_1, OUT_2, OUT_5, OUT_6 of the multi-stage interconnection network 104. Since the plane encoding table LUT_PR assigns a table entry (S1, S2)=(0, 0) to the source (i.e. input port IN_1), the data packet received by the input port IN_1 is forwarded to the switch plane Plane0 through a plane route (UP, UP) provided by the plane routing network 108. Since the destinations are output ports OUT_1, OUT_2, OUT_5, OUT_6, the table entries associated with output ports OUT_1, OUT_2, OUT_5, OUT_6 are selected from the destination encoding table LUT_DR. Hence, the data packet arriving at the switch plane Plane0 is forwarded to the output port OUT_1 through a destination route (Up, Up, Up) provided by the destination routing network 110 in response to (S3, S4, S5)=(0, 0, 0), the data packet arriving at the switch plane Plane0 is also forwarded to the output port OUT_2 through a destination route (Up, Up, Down) provided by the destination routing network 110 in response to (S3, S4, S5)=(0, 0, 1), the data packet arriving at the switch plane Plane0 is also forwarded to the output port OUT_5 through a destination route (Up, Down, Up) provided by the destination routing network 110 in response to (S3, S4, S5)=(0, 1, 0), and the data packet arriving at the switch plane Plane0 is also forwarded to the output port OUT_6 through a destination route (Up, Down, Down) provided by the destination routing network 110 in response to (S3, S4, S5)=(0, 1, 1).

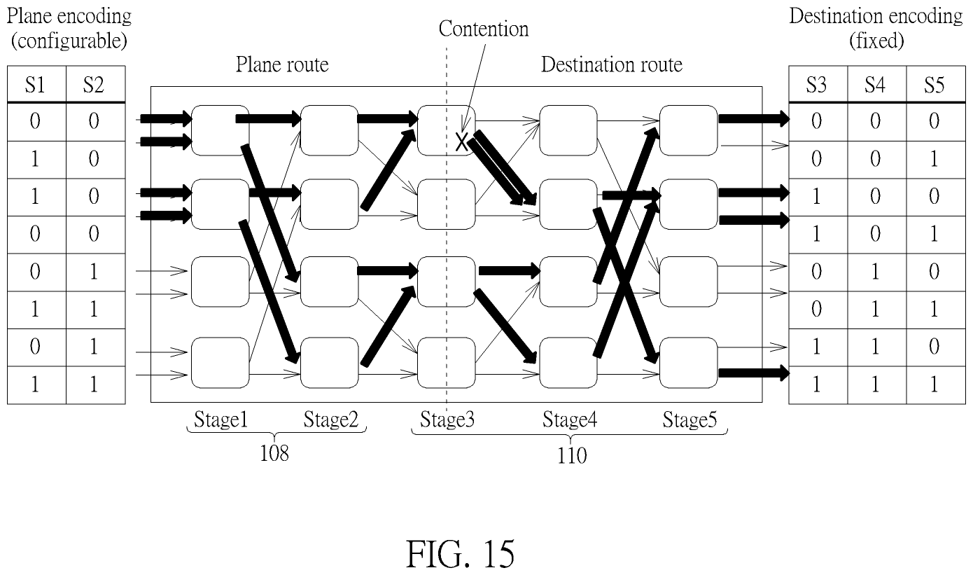

Please refer to FIG. 15 in conjunction with FIG. 8 and FIG. 9. FIG. 15 is a diagram illustrating one unicast routing operation achieved through the multi-stage interconnection network 104 according to an embodiment of the present invention. Suppose that a first data packet received by the input port IN_1 of the multi-stage interconnection network 104 is required to be forwarded to the output port OUT_8 of the multi-stage interconnection network 104, a second data packet received by the input port IN_2 of the multi-stage interconnection network 104 is required to be forwarded to the output port OUT_1 of the multi-stage interconnection network 104, a third data packet received by the input port IN_3 of the multi-stage interconnection network 104 is required to be forwarded to the output port OUT_3 of the multi-stage interconnection network 104, and a fourth data packet received by the input port IN_4 of the multi-stage interconnection network 104 is required to be forwarded to the output port OUT_4 of the multi-stage interconnection network 104. Since the plane encoding table LUT_PR assigns a table entry (S1, S2)=(0, 0) to a first source (i.e. input port IN_1), assigns a table entry (S1, S2)=(1, 0) to a second source (i.e. input port IN_2), assigns a table entry (S1, S2)=(1, 0) to a third source (i.e. input port IN_3), and assigns a table entry (S1, S2)=(0, 0) to a fourth source (i.e. input port IN_4), the first data packet received by the input port IN_1 is forwarded to the switch plane Plane0 through a plane route (UP, UP) provided by the plane routing network 108, the second data packet received by the input port IN_2 is forwarded to the switch plane Plane2 through a plane route (Down, UP) provided by the plane routing network 108, the third data packet received by the input port IN_3 is forwarded to the switch plane Plane2 through a plane route (Down, UP) provided by the plane routing network 108, and the fourth data packet received by the input port IN_4 is forwarded to the switch plane Plane0 through a plane route (UP, UP) provided by the plane routing network 108.

Since the destinations are output ports OUT_8, OUT_1, OUT_3, OUT_4, the table entries associated with output ports OUT_8, OUT_1, OUT_3, OUT_4 are selected from the destination encoding table LUT_DR. Hence, the first data packet arriving at the switch plane Plane0 is forwarded to the output port OUT_8 through a destination route (Down, Down, Down) provided by the destination routing network 110 in response to (S3, S4, S5)=(1, 1, 1), the second data packet arriving at the switch plane Plane2 is forwarded to the output port OUT_1 through a destination route (Up, Up, UP) provided by the destination routing network 110 in response to (S3, S4, S5)=(0, 0, 0), the third data packet arriving at the switch plane Plane2 is forwarded to the output port OUT_3 through a destination route (Down, Up, Up) provided by the destination routing network 110 in response to (S3, S4, S5)=(1, 0, 0), and the fourth data packet arriving at the switch plane Plane0 is forwarded to the output port OUT_4 through a destination route (Down, Up, Down) provided by the destination routing network 110 in response to (S3, S4, S5)=(1, 0, 1).

As shown in FIG. 15, the first data packet arriving at the input port IN_1 and the fourth data packet arriving at the input port IN_4 are forwarded to the same plane Plane0, and the destination route from the switch plane Plane0 to the output port OUT_8 and the destination route from the switch plane Plane0 to the output port OUT_4 have to contend for access of the down route of the 2×2 switch at Stage3 due to the fact that (S3, S4, S5)=(1, 1, 1) and (S3, S4, S5)=(1, 0, 0) have the same setting for the control bit S3 (i.e. S3=1). Since the plane routing table LUT_PR is configurable, the plane routing network 108 can benefit from the path diversity feature to avoid contention. That is, the plane routing table LUT_PR may be adjusted to assign a switch plane with no contention in the following destination route. For example, the control bit pairs assigned to the input ports IN_4 and IN_7 may be swapped under the condition that all design rules as illustrated in FIG. 10-FIG. 12 are still obeyed.

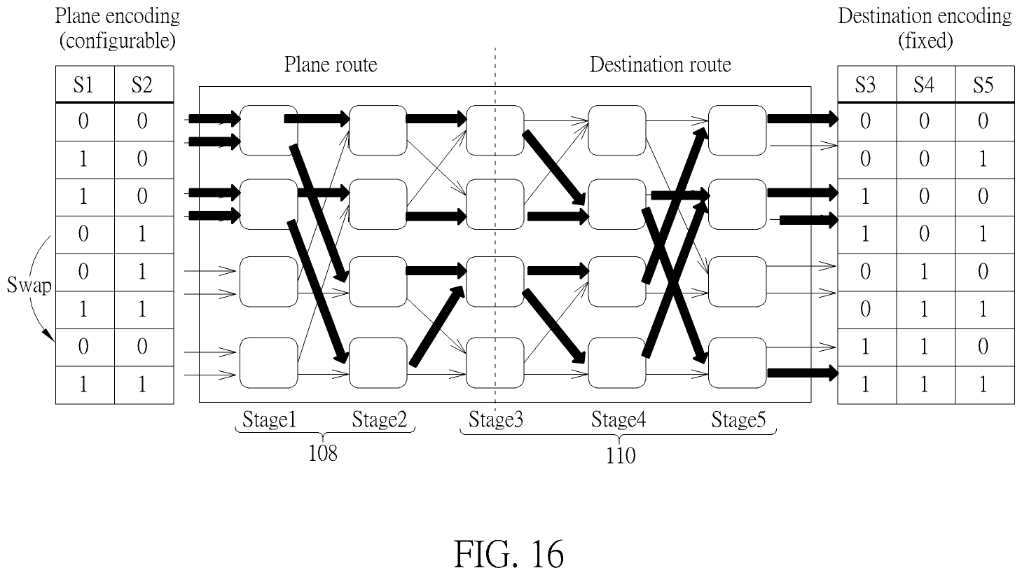

Please refer to FIG. 16 in conjunction with FIG. 8 and FIG. 9. FIG. 16 is a diagram illustrating another unicast routing operation achieved through the multi-stage interconnection network 104 according to an embodiment of the present invention. Suppose that a first data packet received by the input port IN_1 of the multi-stage interconnection network 104 is required to be forwarded to the output port OUT_8 of the multi-stage interconnection network 104, a second data packet received by the input port IN_2 of the multi-stage interconnection network 104 is required to be forwarded to the output port OUT_1 of the multi-stage interconnection network 104, a third data packet received by the input port IN_3 of the multi-stage interconnection network 104 is required to be forwarded to the output port OUT_3 of the multi-stage interconnection network 104, and a fourth data packet received by the input port IN_4 of the multi-stage interconnection network 104 is required to be forwarded to the output port OUT_4 of the multi-stage interconnection network 104. Since the updated plane encoding table LUT_PR assigns a table entry (S1, S2)=(0, 0) to a first source (i.e. input port IN_1), assigns a table entry (S1, S2)=(1, 0) to a second source (i.e. input port IN_2), assigns a table entry (S1, S2)=(1, 0) to a third source (i.e. input port IN_3), and assigns a table entry (S1, S2)=(0, 1) to a fourth source (i.e. input port IN_4), the first data packet received by the input port IN_1 is forwarded to the switch plane Plane0 through a plane route (UP, UP) provided by the plane routing network 108, the second data packet received by the input port IN_2 is forwarded to the switch plane Plane2 through a plane route (Down, UP) provided by the plane routing network 108, the third data packet received by the input port IN_3 is forwarded to the switch plane Plane2 through a plane route (Down, UP) provided by the plane routing network 108, and the fourth data packet received by the input port IN_4 is forwarded to the switch plane Plane1 through a plane route (UP, Down) provided by the plane routing network 108.

Since the destinations are output ports OUT_8, OUT_1, OUT_3, OUT_4, the table entries associated with output ports OUT_8, OUT_1, OUT_3, OUT_4 are selected from the destination encoding table LUT_DR. Hence, the first data packet arriving at the switch plane Plane0 is forwarded to the output port OUT_8 through a destination route (Down, Down, Down) provided by the destination routing network 110 in response to (S3, S4, S5)=(1, 1, 1), the second data packet arriving at the switch plane Plane2 is forwarded to the output port OUT_1 through a destination route (Up, Up, UP) provided by the destination routing network 110 in response to (S3, S4, S5)=(0, 0, 0), the third data packet arriving at the switch plane Plane2 is forwarded to the output port OUT_3 through a destination route (Down, Up, Up) provided by the destination routing network 110 in response to (S3, S4, S5)=(1, 0, 0), and the fourth data packet arriving at the switch plane Plane1 is forwarded to the output port OUT_4 through a destination route (Down, Up, Down) provided by the destination routing network 110 in response to (S3, S4, S5)=(1, 0, 1). It should be noted that, with proper configuration of the configurable plane encoding table LUT_PR, there is no contention between the destination route from the switch plane Plane0 to the output port OUT_8 and the destination route from the switch plane Plane1 to the output port OUT_4. To put it simply, the configurable plane encoding table LUT_PR can be set to ensure that each plane route meets the switch mode constraints and there is no contention occurring in the following destination route.

As mentioned above, the proposed multi-stage interconnection network 104 supports a multicast/broadcast (one-to-many) function for spatial data reuse. When the proposed multi-stage interconnection network 104 is employed by a spatial DNN accelerator, low energy consumption can be achieved due to the fact that the number of memory accesses can be effectively reduced. In some embodiments of the present invention, the proposed multi-stage interconnection network 104 employed by a spatial DNN accelerator may further support a low-power multicast mode for lower power consumption. Furthermore, since the proposed multi-stage interconnection network 104 adopts a Benes topology, the number of switches can be reduced. In addition, the DNN accelerator 100 using the proposed multi-stage interconnection network 104 is immune to the problems encountered by the typical spatial DNN accelerator as described in the above background section.

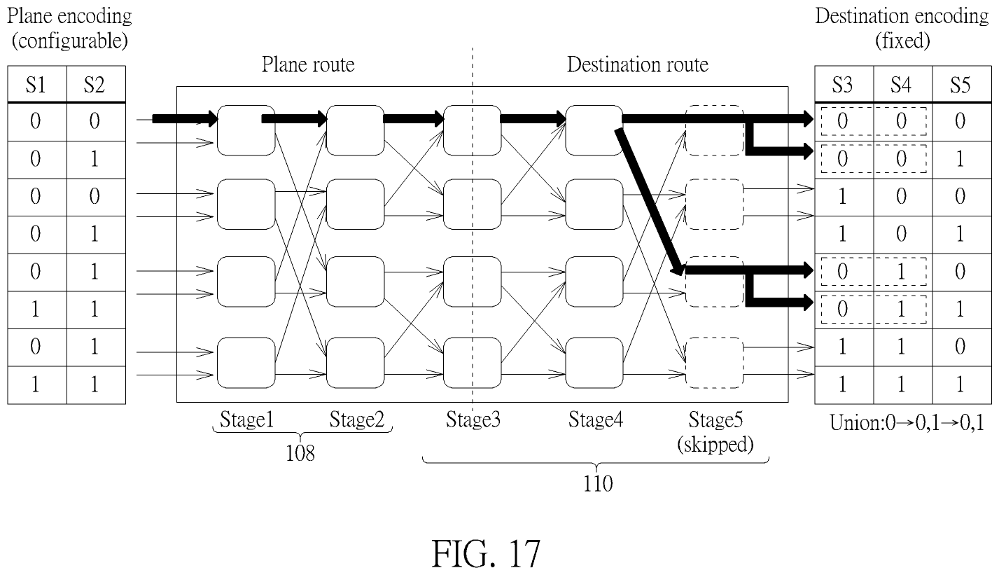

FIG. 17 is a diagram illustrating a first type of the low-power multicast mode according to an embodiment of the present invention. When the same data packet received by one input port (e.g. IN_1) is forwarded to two neighboring cores through two neighboring output ports (e.g. OUT_1 and OUT_2, or OUT_5 and OUT_6), 2×2 switch (es) at Stage5 can be skipped, and the data packet is bypassed by 2×2 switch (es) at stage5. For example, the multiplexers 302 and 303 shown in FIG. 3 may be disabled (powered down) for power saving, and the data packet is transmitted from the input in0/in1 to both outputs out0 and out1 through fixed bypass paths. Since the multiplexers 302 and 303 are disabled (powered down), the power consumption of the 2×2 switch 300 under the low-power multicast mode can be reduced.

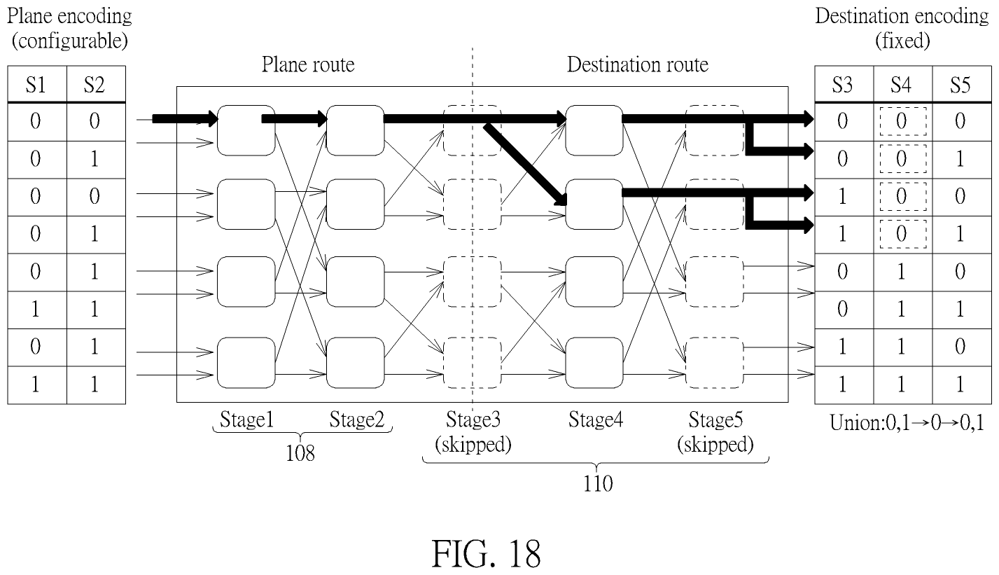

FIG. 18 is a diagram illustrating a second type of the low-power multicast mode according to an embodiment of the present invention. When the same data packet received by one input port (e.g. IN_1) is forwarded to four neighboring cores through four neighboring output ports (e.g. OUT_1, OUT_2, OUT_3 and OUT_4), 2×2 switch (es) at Stage 3 and Stage5 can be skipped, and the data packet is bypassed by 2×2 switch (es) at Stage 3 and Stage5.

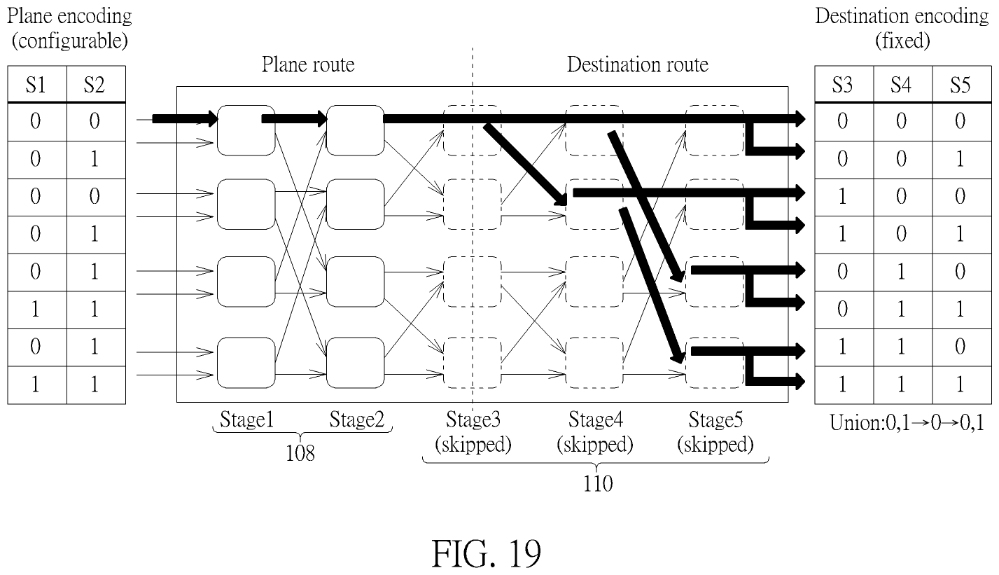

FIG. 19 is a diagram illustrating a third type of the low-power multicast mode according to an embodiment of the present invention. When the same data packet received by one input port (e.g. IN_1) is broadcasted to all cores through all output ports (e.g. OUT_1-OUT_8), 2×2 switch (es) at Stage3, Stage 4, and Stage5 can be skipped, and the data packet is bypassed by 2×2 switch (es) at Stage 3, Stage 4, and Stage5.

In above embodiment, the proposed multi-stage interconnection network 104 acts as a high energy-efficiency interconnection network for the spatial DNN accelerator 100. However, this is for illustrative purposes only, and is not meant to be a limitation of the present invention. For example, the proposed multi-stage interconnection network may be employed by a router in a network-on-chip (NoC) based artificial intelligence (AI) cloud server. In this way, the router inherits advantages from the architecture of the proposed multi-stage interconnection network and the proposed non-blocking up-down routing.

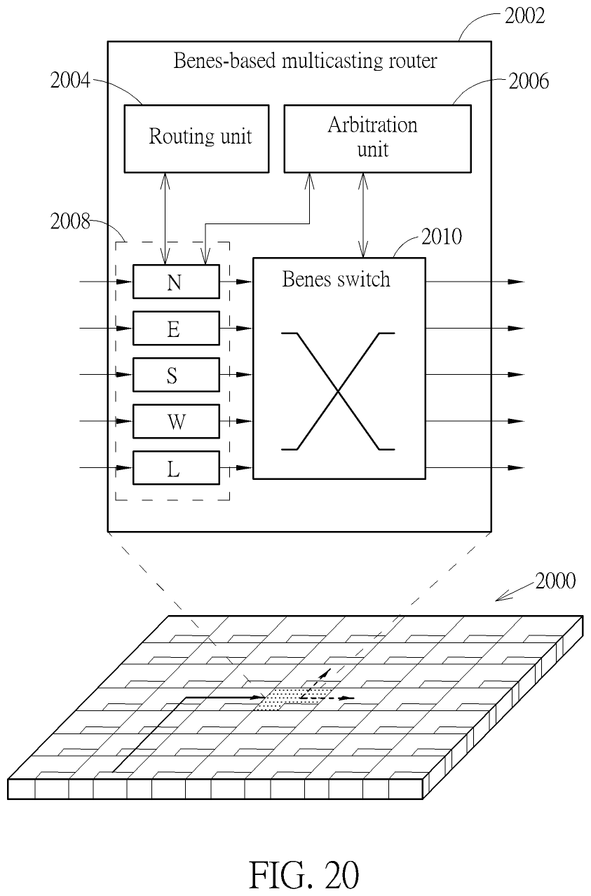

FIG. 20 is a diagram illustrating an NoC-based AI cloud server according to an embodiment of the present invention. The NoC-based AI cloud server 2000 includes a plurality of Benes-based multicasting routers 2002, each including a routing unit 2004, an arbitration unit 2006, an input buffer 2008, and a Benes switch 2010. In contrast to a typical router using a crossbar switch, the Benes-based multicasting router 2002 employs the Benes switch 2010 that may be implemented by the proposed multi-stage interconnection network 104, where the proposed multi-stage interconnection network 104 is controlled by the configurable plane encoding table LUT_PR and the fixed destination encoding table LUT_DR. Compared to the typical crossbar switch, the Benes switch 2010 has lower complexity. In addition, with the use of the Benes switch 2010, the Benes-based multicasting router 2002 supports multicast/broadcast (one-to-many) function for data reuse and a unicast (one-to-one) function for parallel data access, and is suitable for AI cloud computing.

Those skilled in the art will readily observe that numerous modifications and alterations of the device and method may be made while retaining the teachings of the invention. Accordingly, the above disclosure should be construed as limited only by the metes and bounds of the appended claims.

1. A multi-stage interconnection network comprising:
an M-stage plane routing network, arranged to route a data packet received by an input port of the multi-stage interconnection network to a switch plane according to an M-bit entry selected from a plane encoding table, wherein M bits of the M-bit entry control M stages of the M-stage plane routing network, respectively; and
an N-stage destination routing network, arranged to route the data packet from the switch plane to at least one output port of the multi-stage interconnection network according to at least one N-bit entry selected from a destination encoding table, wherein N bits of each of said at least one N-bit entry control N stages of the N-stage destination routing network, respectively;
wherein the multi-stage interconnection network employs a non-blocking network topology, and a sum of M and N is a positive integer not smaller than two; wherein the N-stage destination routing network routes a same data packet from the switch plane to multiple output ports of the multi-stage interconnection network according to multiple N-bit entries selected from the destination encoding table, where the same data packet is the data packet received by the input port;
wherein each of the M-stage plane routing network and the N-stage destination routing network comprises a plurality of multiplexer circuits;
wherein in response to the multiple output ports being neighboring ports, at least one stage of the N-stage destination routing network is skipped, multiplexers of said at least one stage are powered down, and the data packet is bypassed by bypass paths of said at least one stage.

2. The multi-stage interconnection network of claim 1, wherein the plane encoding table is configurable, and the destination encoding table is fixed.

3. The multi-stage interconnection network of claim 1, wherein the non-blocking network topology is a Benes topology.

4. The multi-stage interconnection network of claim 1, wherein the plane encoding table has a plurality of M-bit entries corresponding to a plurality of input ports of the multi-stage interconnection network, respectively.

5. The multi-stage interconnection network of claim 1, wherein all plane routing paths specified by the plane encoding table are constrained to ensure that each 2×2 switch included in any of said all plane routing paths meets one of a pass mode and a cross mode.

6. The multi-stage interconnection network of claim 1, wherein the destination encoding table has a plurality of N-bit entries corresponding to a plurality of output ports of the multi-stage interconnection network, respectively.

7-8. (canceled)

9. The multi-stage interconnection network of claim 1, wherein the multiple output ports are all output ports of the multi-stage interconnection network, and a number of said at least one stage is equal to N.

10. The multi-stage interconnection network of claim 1, wherein the multi-stage interconnection network is a part of a spatial deep neural network (DNN) accelerator.

11. The multi-stage interconnection network of claim 1, wherein the multi-stage interconnection network is a part of a router used in a network-on-chip (NoC) based artificial intelligence (AI) cloud server.

12. A control method of a multi-stage interconnection network comprising:
selecting an M-bit entry from a plane encoding table for controlling an M-stage plane routing network included in the multi-stage interconnection network to route a data packet received by an input port of the multi-stage interconnection network to a switch plane, wherein M bits of the M-bit entry control M stages of the M-stage plane routing network, respectively; and
selecting at least one N-bit entry from a destination encoding table for controlling an N-stage destination routing network included in the multi-stage interconnection network to route the data packet from the switch plane to at least one output port of the multi-stage interconnection network, wherein N bits of each of said at least one N-bit entry control N stages of the N-stage destination routing network, respectively;
wherein the multi-stage interconnection network employs a non-blocking network topology, and a sum of M and N is a positive integer not smaller than two;
wherein selecting said at least one N-bit entry from the destination encoding table for controlling the N-stage destination routing network comprises:
controlling the N-stage destination routing network to route a same data packet from the switch plane to multiple output ports of the multi-stage interconnection network according to multiple N-bit entries selected from the destination encoding table, where the same data packet is the data packet received by the input port; and
in response to the multiple output ports being neighboring ports, skipping at least one stage of the N-stage destination routing network, and powering down multiplexers of said at least one stage, wherein the data packet is bypassed by bypass paths of said at least one stage.

13. The control method of claim 12, wherein the plane encoding table is configurable, and the destination encoding table is fixed.

14. The control method of claim 12, wherein the non-blocking network topology is a Benes topology.

15. The control method of claim 12, wherein the plane encoding table has a plurality of M-bit entries corresponding to a plurality of input ports of the multi-stage interconnection network, respectively.

16. The control method of claim 12, further comprising:
setting the plane encoding table, wherein all plane routing paths specified by the plane encoding table are constrained to ensure that each 2×2 switch included in any of said all plane routing paths meets one of a pass mode and a cross mode.

17. The control method of claim 12, wherein the destination encoding table has a plurality of N-bit entries corresponding to a plurality of output ports of the multi-stage interconnection network, respectively.

18-19. (canceled)

20. The control method of claim 12, wherein the multiple output ports are all output ports of the multi-stage interconnection network, and a number of said at least one stage is equal to N.

21. The control method of claim 12, wherein the multi-stage interconnection network is a part of a spatial deep neural network (DNN) accelerator.

22. The control method of claim 12, wherein the multi-stage interconnection network is a part of a router used in a network-on-chip (NoC) based artificial intelligence (AI) cloud server.
